(19) United States
(12) Patent Application Publication
(10) Pub. No.: US 2021/0024328 A1
(43) Pub. Date: Jan. 28, 2021

(54) ELEVATOR LOAD BEARING MEMBER HAVING A JACKET INCLUDING A FLUOROPOLYMER

(71) Applicant: OTIS ELEVATOR COMPANY, Farmington, CT (US)

(72) Inventor: Chen qian ZHAO, Newark, DE (US)

(21) Appl. No.: 16/517,946

(22) Filed: Jul. 22, 2019

(51) Int. Cl. B66B 7/06; D07B 1/22

(52) U.S. Cl. CPC B66B 7/062; D07B 1/22; D07B 2205/2064; D07B 2205/2003; D07B 2205/2071; D07B 2501/2007

(57) ABSTRACT

An illustrative example embodiment of an elevator load bearing member includes a plurality of load bearing cords and a jacket at least partially surrounding the cords. The jacket includes an inner portion received on the cords and a fluoropolymer outer portion that establishes a fire-resistant exterior of the jacket.

### BACKGROUND

A variety of elevator systems are known. Some elevator systems use a hydraulic arrangement for moving the elevator car. Others are traction-based and include roping that suspends the elevator car and a counterweight. A machine causes movement of a traction sheave that, in turn, causes movement of the roping for moving the elevator car as desired.

For many years, roping in elevator systems included round steel ropes. More recently, flat belt technologies were developed that provided advantages over traditional, round steel rope arrangements. Even with the advancement, those skilled in the art have been striving to improve elevator load bearing member technology.

### SUMMARY

An illustrative example embodiment of an elevator load bearing member includes a plurality of load bearing cords and a jacket at least partially surrounding the cords. The jacket includes an inner portion received on the cords and a fluoropolymer outer portion that establishes a fire-resistant exterior of the jacket.

In an example embodiment having one or more features of the elevator load bearing member of the previous paragraph, the fluoropolymer portion completely encases the inner portion.

In an example embodiment having one or more features of the elevator load bearing member of any of the previous paragraphs, the fluoropolymer portion comprises a functional fluoropolymer.

In an example embodiment having one or more features of the elevator load bearing member of any of the previous paragraphs, the fluoropolymer portion comprises tetrafluoroethylene-ethylene copolymer

In an example embodiment having one or more features of the elevator load bearing member of any of the previous paragraphs, the fluoropolymer portion comprises a perfluoroalkoxy alkane.

In an example embodiment having one or more features of the elevator load bearing member of any of the previous paragraphs, the fluoropolymer portion comprises a copolymer of tetrafluoroethylene and a perfluorinated vinyl ether.

In an example embodiment having one or more features of the elevator load bearing member of any of the previous paragraphs, the functional fluoropolymer comprises a functional group comprising at least one of anhydride, silane, glycidyl, and isocyanate.

In an example embodiment having one or more features of the elevator load bearing member of any of the previous paragraphs, a ratio of an amount of a material of the inner portion to an amount of fluoropolymer is in a range from 1:2 to 1:40.

In an example embodiment having one or more features of the elevator load bearing member of any of the previous paragraphs, the ratio is in a range from 1:5 to 1:20.

In an example embodiment having one or more features of the elevator load bearing member of any of the previous paragraphs, the ratio is 1:8 or 1:15.

An illustrative example embodiment of a method of making an elevator load bearing member includes forming an inner portion of a jacket on a plurality of load bearing cords and establishing a fire-resistant fluoropolymer portion on the inner portion to define an exterior of the jacket.

In an example embodiment having one or more features of the method of the previous paragraph, the forming and the establishing are performed by coextruding a material of the inner portion and the fluoropolymer of the fluoropolymer portion.

An example embodiment having one or more features of the method of any of the previous paragraphs includes separately forming the inner portion and at least one layer of fluoropolymer material and laminating the at least one layer and the formed inner portion

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an elevator system including a load bearing member designed according to an embodiment of this invention.

FIG. 2 schematically illustrates an example embodiment of an elevator load bearing member.

FIG. 3 schematically illustrates selected features of a process for making an elevator load bearing member like that shown in FIG. 2.

FIG. 4 schematically illustrates another example embodiment of a process for making an elevator load bearing member like that shown in FIG. 2.

### DETAILED DESCRIPTION

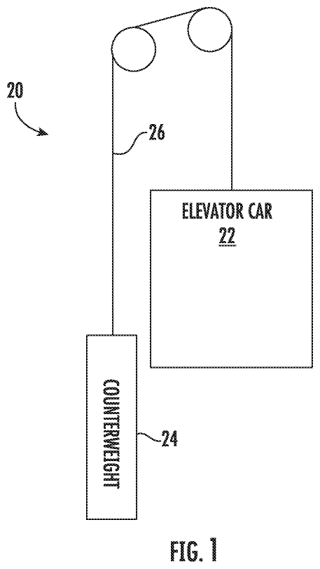

FIG. 1 schematically shows selected portions of an elevator system 20. An elevator car 22 and counterweight 24 are suspended by a load bearing member 26. A traction sheave 28 associated with a machine (not specifically illustrated) selectively controls movement of the load bearing member 26 to control the movement or position of the elevator car 22. For illustration purposes, a single load bearing member 26 is represented in FIG. 1. Multiple load bearing members would be included in many embodiments.

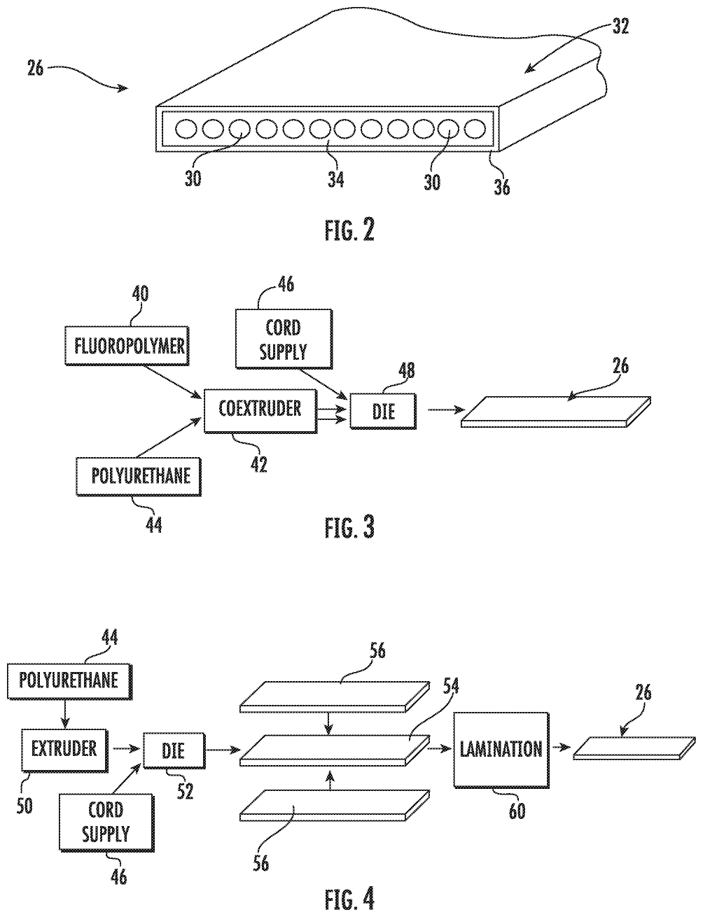

FIG. 2 schematically illustrates an example load bearing member 26 including a plurality of load bearing cords 30 that are at least partially surrounded by a jacket 32. The cords 30 may comprise a variety of materials that are useful for supporting the loads of the elevator system 20. In some embodiments, the cords 30 comprise steel and each include a plurality of wires. Other embodiments include cords 30 made of aluminum, carbon fiber, or liquid crystal polymer, for example.

The jacket 32 includes An inner portion or layer 34 that is received against the cords 30. The inner portion 34 comprises a compressible material that provides good adhesion with the cords 30 to provide adequate pullout strength to maintain the desired configuration of the load bearing member 26 over its useful life. Example embodiments include inner portions 34 that comprise at least one of polyurethane, polyamide, polyester, or ethylene propylene diene monomer rubber (EPDM).

The jacket 32 also includes a fluoropolymer portion or layer 36 that establishes a fire-resistant exterior of the jacket 32. In the illustrated embodiment, the fluoropolymer portion 36 surrounds the first portion 34 and establishes the entire exterior of the jacket 32. The fluoropolymer portion 36 is self-extinguishing and resistant to igniting, melting or dripping when exposed to fire or other high-temperature conditions. Including the fluoropolymer portion 36 gives fire-resistant properties to the load bearing member 26 while establishing an exterior surface on the jacket 32 that provides the necessary traction for controlling the movement and position of the elevator car 22.

The fluoropolymer portion 36 in at least some embodiments also improves the wear characteristics of the jacket 32, which can extend the useful life of the load bearing member 26. For example, a fluoropolymer has superior hardness, breaking stress and tensile elongation at break properties compared to a polyurethane so a jacket including an exterior fluoropolymer portion 36 has superior wear characteristics compared to previously used jacket materials. Moreover, the fluoropolymer portion 36 provides better mechanical performance properties for such a jacket compared to blends of polyurethanes with fire-retardant agents.

The fluoropolymer in an example embodiment comprises tetrafluoroethylene-ethylene copolymer. Another example embodiment includes a perfluoroalkoxy alkane, such as copolymer of tetrafluoroethylene and a perfluorinated vinyl ether that has been functionalized to include an adhesive group within the polymer backbone. Such materials do not melt or drip when exposed to flame and give the jacket 32 excellent fire resistant properties including the ability to maintain the geometry of the load bearing member 26.

The fluoropolymer material in some embodiments comprises a functional fluoropolymer including a functional group such as anhydride, silane, glycidyl, isocyanate, carboxylic acid, amine, and amide.

FIG. 3 schematically illustrates an example method of making the example load bearing member 26. A resin of the fluoropolymer material 40 of the fluoropolymer portion 36 is fed into a coextruder 42 along with a resin of the material 44 of the inner portion 34, which is polyurethane in the illustrated example embodiment. The cords 30 are fed from a cord supply 46 into a die 48. The coextruder 42 coextrudes the inner portion 34 onto the cords 30 in a first or inner section of the die 48 and the fluoropolymer portion 36 onto the inner portion 34 in a second or outer section of the die 48. The adhesion properties of the materials used in the coextrusion are sufficient to secure the fluoropolymer portion 36 to the inner portion 34 without requiring additional adhesive layers between them.

Another example method is illustrated in FIG. 4. In this embodiment, the resin of the material 44 of the inner portion 34 is fed into an extruder 50 that extrudes the inner portion 34 onto the cords 30 within a die 52. The resulting structure 54 includes cords 30 encased in the polyurethane material. Preformed layers 56 of fluoropolymer are situated against the structure 54 and laminated together at 60. The resulting load bearing member 26 includes the fluoropolymer portion 36 surrounding the inner portion 34 as shown in FIG. 2, for example.

The jacket 32 may include various amounts of the respective materials of the inner portion 34 and the fluoropolymer portion 36. A ratio of the amount of inner portion 34 material to the amount of fluoropolymer portion 36 material in the jacket 32 is in a range from 1:2 to 1:40. An example embodiment includes a ratio of those materials in the range from 1:5 to 1:20. One example embodiment has a preferred ratio of 1:8 or 1:15.

A load bearing member designed according to an embodiment of this invention may have a different configuration than the flat belt style of load bearing member in the illustrations and described above. For example, the load bearing member may have a round cross-section.

Including a fluoropolymer portion as the exterior of the jacket provides smoke-suppressant and fire-resistant properties including avoiding dripping or melting of the jacket 32. The fluoropolymer provides such protection along with superior mechanical performance compared to elevator load bearing member jacket compositions that attempted to incorporate fire resistant materials in to a blend with a polyurethane or other jacket material.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. An elevator load bearing member, comprising:
a plurality of load bearing cords; and
a jacket at least partially surrounding the cords, the jacket including an inner portion received against the cords and a fluoropolymer portion that establishes a fire-resistant exterior of the jacket.

2. The elevator load bearing member of claim 1, wherein the fluoropolymer portion completely encases the inner portion.

3. The elevator load bearing member of claim 1, wherein the fluoropolymer portion comprises a functional fluoropolymer.

4. The elevator load bearing member of claim 3, wherein the fluoropolymer portion comprises tetrafluoroethylene-ethylene copolymer

5. The elevator load bearing member of claim 3, wherein the fluoropolymer portion comprises a perfluoroalkoxy alkane.

6. The elevator load bearing member of claim 5, wherein the fluoropolymer portion comprises a copolymer of tetrafluoroethylene and a perfluorinated vinyl ether.

7. The elevator load bearing member of claim 3, wherein the functional fluoropolymer comprises a functional group comprising at least one of anhydride, silane, glycidyl, and isocyanate.

8. The elevator load bearing member of claim 1, wherein a ratio of an amount of a material of the inner portion to an amount of fluoropolymer is in a range from 1:2 to 1:40.

9. The elevator load bearing member of claim 8, wherein the ratio is in a range from 1:5 to 1:20.

10. The elevator load bearing member of claim 8, wherein the ratio is 1:8 or 1:15.

11. A method of making an elevator load bearing member, the method comprising:
forming an inner portion of a jacket on a plurality of load bearing cords; and
establishing a fire-resistant fluoropolymer portion on the inner portion to define an exterior of the jacket.

12. The method of claim 11, wherein the forming and the establishing are performed by coextruding a material of the inner portion and the fluoropolymer of the fluoropolymer portion.

13. The method of claim 11, comprising
separately forming the inner portion and at least one layer of fluoropolymer material; and
laminating the at least one layer and the formed inner portion.
